(19) United States
(12) Patent Application Publication
(10) Pub. No.: US 2025/0209650 A1
(43) Pub. Date: Jun. 26, 2025

(54) INFORMATION PROCESSING APPARATUS, SYSTEM, INFORMATION PROCESSING METHOD, INFORMATION PROCESSING PROGRAM, AND COMPUTER SYSTEM

(71) Applicant: Sony Interactive Entertainment Inc., Tokyo (JP)

(72) Inventors: Naoyuki MIYADA, Tokyo (JP); Hideaki IWAKI, Tokyo (JP)

(73) Assignee: Sony Interactive Entertainment Inc., Tokyo (JP)

(21) Appl. No.: 18/848,537

(22) PCT Filed: Mar. 30, 2022
(86) PCT No.: PCT/JP2022/016252

§ 371 Date: Sep. 19, 2024

(51) Int. Cl. G06T 7/55; G06T 7/20; G06T 7/521; H04N 25/47

(52) U.S. Cl. CPC G06T 7/55; G06T 7/20; G06T 7/521; H04N 25/47; G06T 2207/10048

(57) ABSTRACT

There is provided an information processing apparatus that calculates distance information regarding a distance to a target irradiated with light with a predetermined pattern, the information processing apparatus including an identification section that identifies at least one area in an image acquired using a frame-based vision sensor, a tracking section that tracks a target area corresponding to the area identified by the identification section, on the basis of an event signal output by an event-based sensor, and a calculation section that calculates, for each of the target areas, the distance information on the basis of a difference between an irradiation start time and a light reception time for the light with the predetermined pattern.

### TECHNICAL FIELD

The present invention relates to an information processing apparatus, a system, an information processing method, an information processing program, and a computer system.

### BACKGROUND ART

There is known an event-based sensor in which a pixel detecting a change in the intensity of incident light generates a signal in a time-asynchronous manner. Compared to a frame-based vision sensor that scans all pixels with a predetermined period, specifically, an image sensor such as a CCD (Charge Coupled Device) or a CMOS (Complementary Metal Oxide Semiconductor), the event-based sensor is advantageous in view of capability of operating at high speed with reduced power. A technology related to such an event-based sensor is described in PTL 1 and PTL 2.

### CITATION LIST

### Patent Literature

[PTL 1]
Japanese Translations of PCT for Patent No. 2014-535098
[PTL 2]
Japanese Patent Laid-Open No. 2018-85725

### SUMMARY

### Technical Problem

However, in spite of the known advantages of the event-based sensor described above, usage of the event-based sensor in combination with other apparatuses has been far from being sufficiently proposed.

Thus, an object of the present invention is to provide an information processing apparatus, a system, an information processing method, an information processing program, and a computer system that can improve the accuracy of calculation of distance information by using the event-based sensor to calculate complementary information that complements the distance information.

### Solution to Problem

An aspect of the present invention provides an information processing apparatus that calculates distance information regarding a distance to a target irradiated with light with a predetermined pattern, the information processing apparatus including an identification section that identifies at least one area in an image acquired using a frame-based vision sensor, a tracking section that tracks a target area corresponding to the area identified by the identification section, on the basis of an event signal output by an event-based sensor, and a calculation section that calculates, for each of the target areas, the distance information on the basis of a difference between an irradiation start time and a light reception time for the light with the predetermined pattern.

Another aspect of the present invention provides a system including a frame-based vision sensor, an event-based sensor, an irradiation section that irradiates a target with light with a predetermined pattern, and a light receiving section that receives reflected light from the target, and an information processing apparatus including an identification section that identifies at least one area in an image acquired using the frame-based vision sensor, a tracking section that tracks a target area corresponding to the area identified by the identification section, on the basis of an event signal output by the event-based sensor, and a calculation section that calculates, for each of the target areas, the distance information on the basis of a difference between an irradiation start time and a light reception time for the light with the predetermined pattern.

Yet another aspect of the present invention provides an information processing method of calculating distance information regarding a distance to a target irradiated with light with a predetermined pattern, the information processing method including an identification step of identifying at least one area in an image acquired using a frame-based vision sensor, a tracking step of tracking a target area corresponding to the identified area on the basis of an event signal output by an event-based sensor, and a calculation step of calculating, for each of the target areas, the distance information on the basis of a difference between an irradiation start time and a light reception time for the light with the predetermined pattern.

Still another aspect of the present invention provides an information processing program causing a computer to implement processing of calculating distance information regarding a distance to a target irradiated with light with a predetermined pattern, the information processing program causing the computer to implement a function of identifying at least one area in an image acquired using a frame-based vision sensor, a function of tracking a target area corresponding to the identified area on the basis of an event signal output by an event-based sensor, and a function of calculating, for each of the target areas, the distance information on the basis of a difference between an irradiation start time and a light reception time for the light with the predetermined pattern.

Further another aspect of the present invention provides a computer system including a memory configured to store a program code, and a processor configured to process the program code to execute an operation, the operation including identifying at least one area in an image acquired using a frame-based vision sensor, tracking a target area corresponding to the identified area on the basis of an event signal output by an event-based sensor, and calculating, for each of the target areas, the distance information on the basis of a difference between an irradiation start time and a light reception time for the light with the predetermined pattern.

### BRIEF DESCRIPTION OF DRAWINGS

FIG. 1 is a block diagram illustrating a schematic configuration of a system according to a first embodiment of the present invention.

FIG. 2 is a diagram illustrating calculation of distance information in the first embodiment of the present invention.

FIG. 3A is another diagram illustrating calculation of complementary information in the first embodiment of the present invention.

FIG. 3B is still another diagram illustrating calculation of complementary information in the first embodiment of the present invention.

FIG. 4 is a flowchart illustrating an example of a processing method according to the first embodiment of the present invention.

FIG. 5 is another flowchart illustrating an example of a processing method according to the first embodiment of the present invention.

FIG. 6 is a block diagram illustrating a schematic configuration of a system according to a second embodiment of the present invention.

FIG. 7 is a diagram illustrating identification of a rectangular area in the second embodiment of the present invention.

FIG. 8 is a diagram illustrating tracking in the second embodiment of the present invention.

FIG. 9 is a flowchart illustrating an example of a processing method according to the second embodiment of the present invention.

FIG. 10 is another flowchart illustrating an example of a processing method according to the second embodiment of the present invention.

FIG. 11 is a block diagram illustrating a schematic configuration of a system according to a third embodiment of the present invention.

### DESCRIPTION OF EMBODIMENTS

Several embodiments of the present invention will be described below in detail with reference to the attached drawings. Note that, in the specification and the drawings, the same reference signs are used to denote components having substantially the same functions and configurations and that duplicate descriptions are omitted.

### First Embodiment

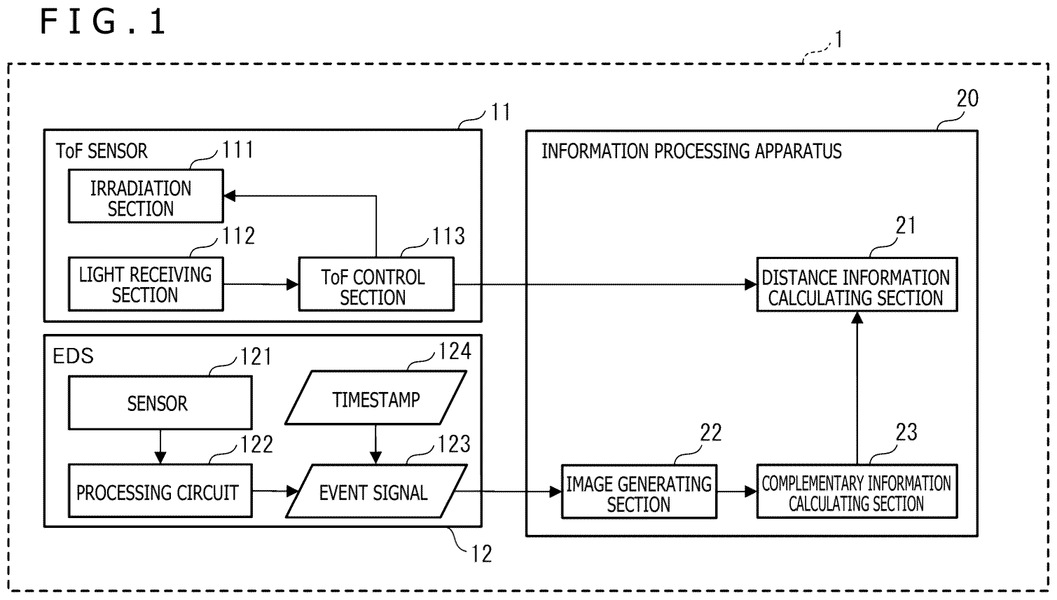

FIG. 1 is a block diagram illustrating a schematic configuration of a system according to a first embodiment of the present invention.

A system 1 includes a ToF (Time of Flight) sensor 11, an EDS (Event Driven Sensor) 12, and an information processing apparatus 20.

The ToF sensor 11 includes, for example, an infrared laser light source, and includes an irradiation section 111 that radiates infrared light with a predetermined pattern, a light receiving section 112 including a light receiving element such as a photodiode, for example, and a ToF control section 113 that controls the irradiation section 111 and the light receiving section 112. The ToF control section 113 controls an irradiation timing for light with the predetermined pattern in the irradiation section 111, and outputs, to the information processing apparatus 20, information indicating an irradiation start time in the irradiation section 111 and a light reception time in the light receiving section 112. The light with the predetermined pattern has a pattern including a figure, and is, for example, a plurality of dot patterns arranged in a lattice manner, a plurality of line patterns arranged at regular intervals, or the like. By way of example, a plurality of dot patterns arranged in a lattice manner will hereinafter be described as an example.

The EDS 12 is an example of an event-based sensor that generates an event signal when the sensor detects a change in the intensity of light, and is an example of a sensor also referred to as a DVS (Dynamic Vison Sensor) or an EVS (Event-based Vision Sensor). The EDS 12 includes a sensor 121 constituting a sensor array and a processing circuit 122 connected to the sensor 121. The sensor 121 is an event-based sensor that includes a light receiving element and generates an event signal 123 upon detecting a change in the intensity of light incident on each pixel, more specifically, a change in luminance exceeding a preset predetermined value. When having detected no change in the intensity of incident light, the sensor 121 does not generate the event signal 123, and thus, the EDS 12 generates the event signal 123 in a time-asynchronous manner. The event signal 123 generated by the EDS 12 is output to the information processing apparatus 20.

The event signal 123 output via the processing circuit 122 includes identification information (for example, the positions of pixels) regarding the sensor 121, the polarity of a change in luminance (increase or decrease), and a timestamp 124. In addition, upon detecting a change in luminance, the EDS 12 can generate the event signal 123 at a significantly higher frequency than that of a frame-based vision sensor.

In general, when light with the predetermined pattern radiated from the irradiation section 111 in the ToF sensor 11 is reflected depending on a target and reflected light is incident on the sensor, the reflected light may be unnecessary for the sensor or may cause adverse effects in the sensor, and is thus blocked or shielded by a shutter, a filter, or the like. However, in the present embodiment, to calculate complementary information that complements distance information calculated by the ToF sensor 11, the above-described reflected light is received by the sensor 121 of the EDS 12 to generate the event signal 123. Calculation of the complementary information will be described below. In addition, in the present embodiment, a calibration procedure for the ToF sensor 11 and the EDS 12 executed in advance associates the light receiving section 112 of the ToF sensor 11 and the sensor 121 of the EDS 12 with each other. More specifically, the light receiving section 112 of the ToF sensor 11 and the sensor 121 of the EDS 12 can be associated with each other by, for example, using the ToF sensor 11 and the EDS 12 to image a common calibration pattern and calculating corresponding parameters between the light receiving section 112 and the sensor 121 from internal parameters and external parameters for each of the ToF sensor 11 and the EDS 12.

The information processing apparatus 20 is implemented by, for example, a computer including a communication interface, a processor, and a memory and includes functions of a distance information calculating section 21, an image generating section 22, and a complementary information calculating section 23 implemented by the processor operating in accordance with a program stored in the memory or received via the communication interface, the processor being configured to process program codes to execute operations. The functions of the sections will further be described below.

The distance information calculating section 21 calculates distance information regarding a distance to a target on the basis of a difference between an irradiation start time when the irradiation section 111 starts irradiation and a light reception time when the light receiving section 112 receives light.

As described above, the irradiation section 111 of the ToF sensor 11 radiates light with a plurality of dot patterns arranged in a lattice manner. Then, light radiated at the same irradiation start time is reflected by each of targets, and reflected light is received by the light receiving section 112 at a time corresponding to the distance to the target. In other words, the light reception time is later for a target present further than for a target present closer.

The distance information calculating section 21 can calculate, for each dot pattern, the distance to the target corresponding to the dot pattern by calculating the difference between the irradiation start time and the light reception time. Note that, for calculation of the distance information based on the ToF sensor 11 and output from the ToF sensor 11, detailed description is omitted because known various technologies are available.

Each time the EDS 12 generates the event signal 123, the image generating section 22 constructs an image (hereinafter referred to as an “event image”) on the basis of the event signal 123, and outputs the image to the complementary information calculating section 23. On the basis of the event image constructed by the image generating section 22, the complementary information calculating section 23 calculates complementary information that complements the distance information calculated by the distance information calculating section 21.

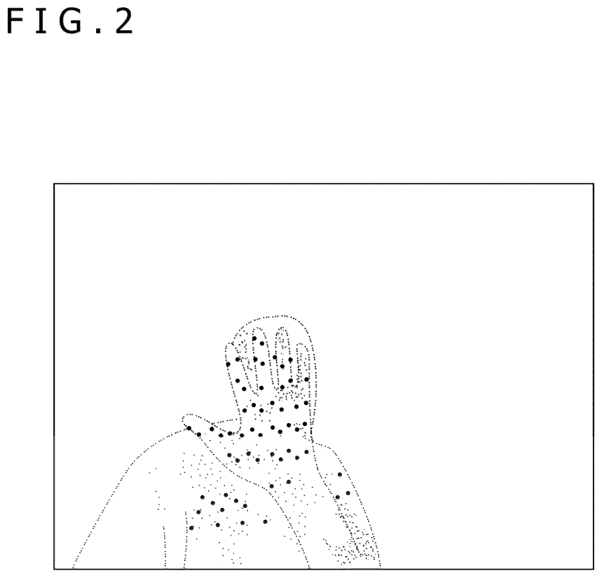

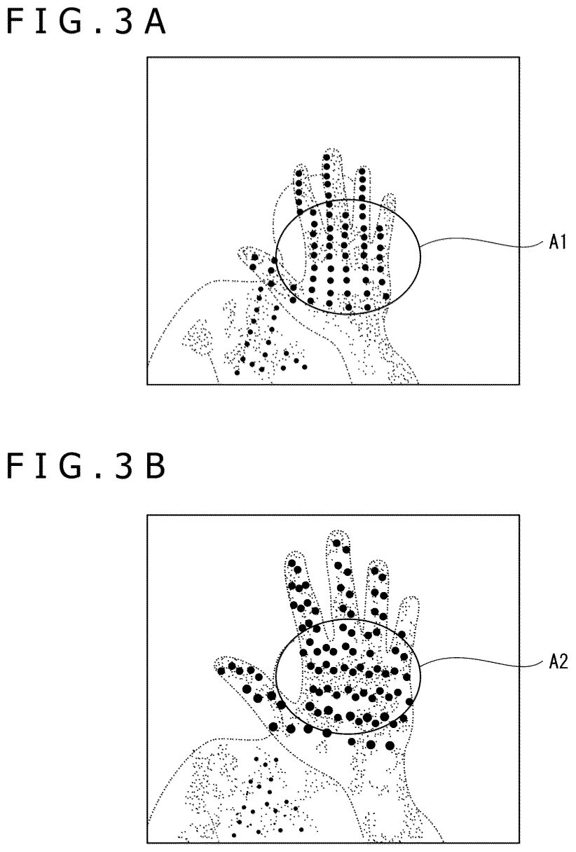

FIG. 2 and FIG. 3 are diagrams for describing an example of calculation of complementary information. FIG. 2 and FIG. 3 illustrate an example of an event image constructed by the image generating section 22.

For example, in a case where the target is a person holding the left hand of the person before the face of the person, the outline of the person, the portion of the hand of the person, or the like makes fine motion in the event image even when the person remains at rest, and portions in which luminance changes occur are drawn, as illustrated in FIG. 2 and FIG. 3.

Further, as described above, the irradiation section 111 of the ToF sensor 11 radiates light with a plurality of dot patterns arranged in a lattice manner. Thus, as illustrated in FIG. 2, in the event image, the dot pattern varies according to the shape of the body of the person.

Subsequently, in a case where the person moves the left hand closer toward the face, in other words, moves the left hand away from the EDS 12, the size of the dots in the event image changes in a direction in which the size decreases, with dot intervals changing in a direction in which the intervals increase, as illustrated in an area A1 in FIG. 3A. On the other hand, in a case where the person moves the left hand away from the face, in other words, moves the left hand closer to the EDS 12, the size of the dots in the event image changes in a direction in which the size increases, with the dot intervals changing in a direction in which the intervals decrease, as illustrated in an area A2 in FIG. 3B.

The complementary information calculating section 23 calculates complementary information that complements the distance information, on the basis of a change in the shape of the dot patterns in the event image constructed by the image generating section 22.

The complementary information includes, for example, information indicating the moving direction of the target, information indicating the moving distance of the target, and the like. As described above, the complementary information calculating section 23 can calculate the moving direction of the target, in other words, information indicating whether the target is moving closer to or away from the ToF sensor 11 and the EDS 12, on the basis of changes in the size or intervals between the dots in a plurality of chronologically successive event images. In addition, the complementary information calculating section 23 can calculate information indicating the approximate moving distance of the target, by, for example, pre-storing the relation between the distance to the target and changes in the shape of a predetermined pattern and comparing the shape of the predetermined pattern among a plurality of chronologically successive event images. In other words, the complementary information calculating section 23 calculates the complementary information on the basis of changes in the size of the dot pattern, the position of the dot pattern, or the like as changes in the shape of the predetermined pattern. Then, the complementary information calculating section 23 outputs the calculated complementary information to the distance information calculating section 21.

As described above, the distance information calculating section 21 calculates the distance to the target corresponding to each dot pattern by calculating the difference between the irradiation start time and the light reception time for each dot pattern on the basis of the output from the ToF sensor 11. However, the frequency at which the distance information is calculated by this calculation method is somewhat limited (for example, 30 frames/second), and calculating the distance information at a higher frame rate is difficult.

Thus, the distance information calculating section 21 realizes an increased frame rate in the time axis direction by complementing the distance information on the basis of the complementary information calculated by the complementary information calculating section 23. After calculating the distance information on the basis of the output from the ToF sensor 11 and before calculating the next distance information on the basis of the output from the ToF sensor 11, the distance information calculating section 21 calculates the latest distance information on the basis of the most recently calculated distance information and the complementary information.

In other words, by applying, to the most recently calculated distance information, the information indicating the moving direction of the target and the information indicating the moving distance of the target described above, the latest distance information can be calculated.

The event signal 123 has relatively high immediacy and is generated only when a luminance change is detected. Thus, by constructing an event image and calculating complementary information each time the event signal 123 is generated, the frequency at which the distance information is calculated on the basis of the output from the ToF sensor 11 can be increased to increase the frame rate in the time axis direction, allowing the accuracy of calculation of the distance information to be improved.

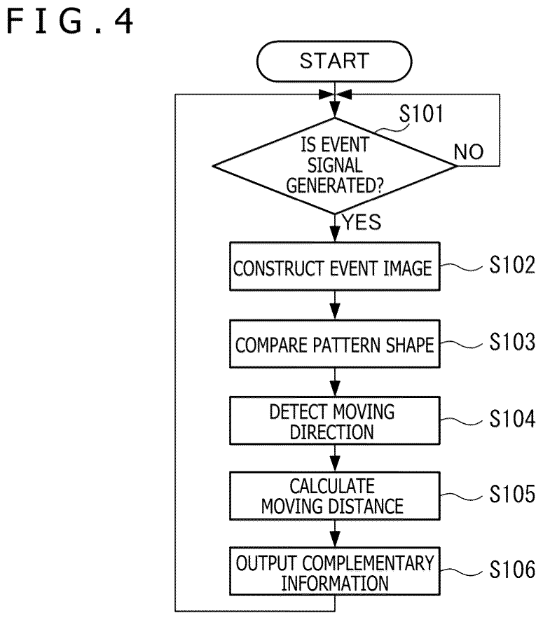

FIG. 4 is a flowchart illustrating an example of processing according to the first embodiment of the present invention. In the illustrated example, when the sensor 121 of the EDS 12 generates an event signal 123 (YES in step S101), the image generating section 22 of the information processing apparatus 20 constructs an event image (step S102). Then, the complementary information calculating section 23 compares the shape of a predetermined pattern (step S103), detects the moving direction of the target (step S104), and calculates the moving distance of the target (step S105). Then, the complementary information calculating section 23 outputs calculated complementary information to the distance information calculating section 21.

Note that the processing of calculating the complementary information includes the processing of detecting the moving direction in step S104 and the processing of calculating the moving distance in step S105 and that these steps may be executed in the reverse order or may be executed simultaneously. The processing of calculating the complementary information may include only any one of the processing of detecting the moving direction and the processing of calculating the moving distance, or may include calculating, as complementary information, information other than the moving direction and the moving distance. In addition, information calculated as complementary information may be set according to an intended use or the like or on the basis of user operation.

By repeating the processing in steps S101 to S106 described above, the sections of the information processing apparatus 20 can calculate complementary information at a timing when the event signal 123 is generated.

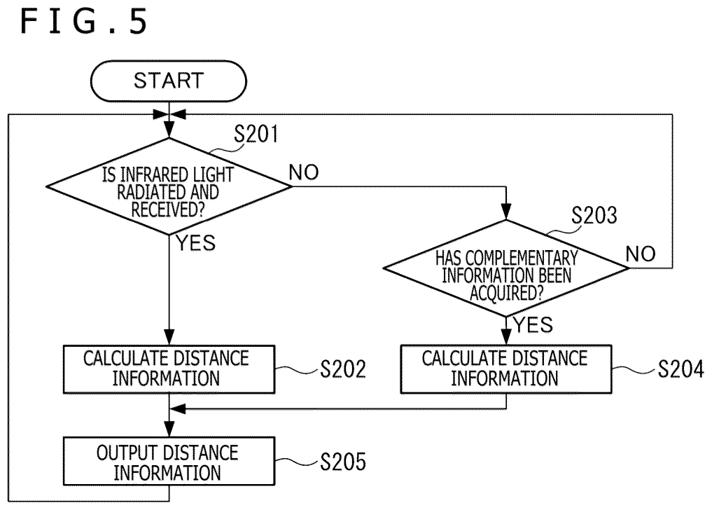

FIG. 5 is a flowchart illustrating another example of processing of the system 1 according to the first embodiment of the present invention. In the illustrated example, processing of calculating distance information is executed according to the complementary information described with reference to FIG. 4.

When infrared light is radiated by the ToF sensor 11 and then received (YES in step S201), the distance information calculating section 21 calculates the distance information regarding the distance to the target on the basis of the difference between the irradiation start time when the irradiation section 111 starts irradiation and the light reception time when the light receiving section 112 receives light (step 202). On the other hand, in a case where no infrared light is radiated or received in spite of passage of a predetermined time (NO in step S201), the distance information calculating section 21 determines whether or not complementary information has been acquired from the complementary information calculating section 23, and upon determining that the complementary information has been acquired (YES in step 203), complements the most recently calculated distance information on the basis of the complementary information to calculate the latest complementary information (step S204). Note that the predetermined time may be set according to the calculation frequency for the distance information based on the output from the ToF sensor 11.

Further, the distance information calculating section 21 outputs, from the information processing apparatus 20, the distance information calculated in step S202 or step S204 (step S205).

By repeating the processing in steps S201 to S205 described above, the sections of the information processing apparatus 20 can calculate the distance information while utilizing the complementary information.

The first embodiment of the present invention described above includes the distance information calculating section 21 that is a first calculation section that calculates, for a target irradiated with light with a predetermined pattern, the distance information regarding the distance to the target, the image generating section 22 that constructs an event image on the basis of the event signal 123 output according to reflected light from the target among the event signals 123 output by the sensor 121 that is an event-based sensor, and the complementary information calculating section 23 that is a second calculation section that calculates complementary information that complements the distance information, on the basis of a change in a shape of a predetermined pattern in the event image.

Therefore, when the complementary information is calculated on the basis of the event signal 123 having a relatively high time resolution, the distance information based on the output from the ToF sensor 11 can be complemented, the ToF sensor 11 being somewhat limited in terms of the calculation frequency. Further, by using the event-based sensor to calculate complementary information that complements the distance information, an increased frame rate in the time axis direction is realized to allow the accuracy of calculation of the distance information to be improved.

In addition, in the first embodiment of the present invention, the light with the predetermined pattern is infrared light, and the distance information calculating section 21 calculates the distance information on the basis of the difference between the irradiation start time and the light reception time for infrared light. In other words, combination with the EDS 12 allows effective utilization of reflected light of infrared light radiated at the ToF sensor 11, to improve the accuracy of calculation of the distance information.

In addition, in the first embodiment of the present invention, the complementary information is information indicating the moving direction of the target or the moving distance of the target. Therefore, by utilizing the characteristics of the event signal 123, complementary information useful in complementing the distance information can be calculated with no increase in processing load.

### Second Embodiment

A second embodiment of the present invention will be described below with reference to the drawings. In the second embodiment, only differences from the first embodiment will be described, and description of portions of the second embodiment similar to those of the first embodiment is omitted. In addition, in the second embodiment, the same reference signs are used to denote components having substantially the same functions and configurations as those in the first embodiment.

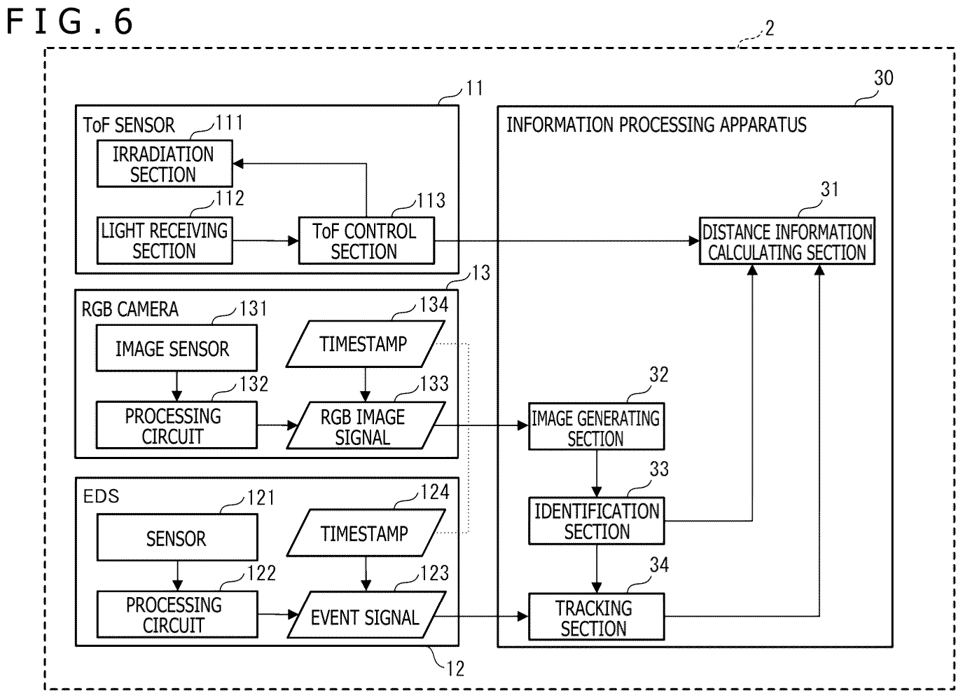

FIG. 6 is a block diagram illustrating a schematic configuration of a system 2 according to a second embodiment of the present invention.

The system 2 according to the second embodiment is a system including an RGB camera 13 in addition to the system 1 of the first embodiment, as illustrated in FIG. 6. In addition, the system 2 includes an information processing apparatus 30 instead of the information processing apparatus 20 of the system 1 of the first embodiment.

The RGB camera 13 includes an image sensor 131 that is a frame-based vision sensor and a processing circuit 132 connected to the image sensor 131. The image sensor 131 generates an RGB image signal 133 by synchronously scanning all pixels, for example, with a predetermined period or at a predetermined timing corresponding to user operation. The processing circuit 132, for example, converts the RGB image signal 133 into a format suitable for saving and transmission. In addition, the processing circuit 132 provides a timestamp 134 to the RGB image signal 133. The RGB image signal 133 generated by the RGB camera 13 is output to the information processing apparatus 30.

In the present embodiment, the timestamp 134 provided to the RGB image signal 133 is synchronous with the timestamp 124 provided to the event signal 123 generated by the EDS 12. Specifically, for example, by providing the RGB camera 13 with time information used for the EDS 12 to generate the timestamp 124, the timestamp 134 can be synchronized with the timestamp 124. Alternatively, in a case where the RGB camera 13 and the EDS 12 have independent pieces of time information used to generate timestamps 124 and 134, by calculating the offset amount of the timestamp using, as a reference, the time when a specific event (for example, the subject is changed all over the image) has occurred, the timestamp 134 in the RGB camera 13 can be synchronized with the timestamp 124 in the EDS 12 in an ex post manner.

In addition, in the present embodiment, when a calibration procedure is executed between the ToF sensor 11 and the EDS 12 and the RGB camera 13 in advance, the ToF sensor 11, the EDS 12, and the RGB camera 13 are associated with one another. For example, the sensor 121 of the EDS 12 is associated with one or a plurality of pixels of the RGB image signal 133, and the event signal 123 is generated according to changes in the intensity of light in the one or plurality of pixels of the RGB image signal 133. More specifically, for example, by using the ToF sensor 11, the EDS 12, and the RGB camera 13 to image a common calibration pattern and calculating corresponding parameters between the camera and the sensor from internal parameters and external parameters for the ToF sensor 11, the EDS 12, and the RGB camera 13, the light receiving section 112 of the ToF sensor 11, the event signal 123, and the RGB image signal 133 can be associated with one another.

The information processing apparatus 30 includes a distance information calculating section 31 instead of the distance information calculating section 21 of the information processing apparatus 20 of the first embodiment, and includes an image generating section 32, an identification section 33, and a tracking section 34 instead of the image generating section 22 and the complementary information calculating section 23.

Each time the RGB camera 13 generates the RGB image signal 133, the image generating section 32 of the information processing apparatus 30 generates an image (hereinafter referred to as an “RGB image”) on the basis of the RGB image signal 133 and outputs the image to the identification section 33. The identification section 33 identifies at least one rectangular area in the RGB image generated by the image generating section 32. The rectangular area can be identified utilizing a known line detection technology (Line Segmentation), and thus, detailed description is omitted.

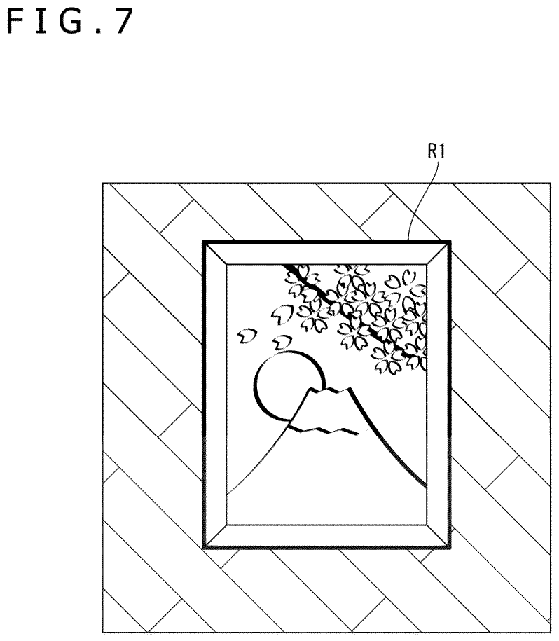

FIG. 7 is a diagram describing identification of a rectangular area. FIG. 7 illustrates an example of an RGB image generated by the image generating section 32. The identification section 33 detects segments in the RGB image by the line detection technology and locates a rectangular area according to correlation between a plurality of segments. In the example in FIG. 7, an example in which an edge portion of a framework is identified as a rectangular area R1 is provided. The identification section 33 outputs information indicating the identified rectangular area to both the distance information calculating section 31 and the tracking section 34. Note that, in a case where a plurality of rectangular areas is present in the RGB image, the identification section 33 identifies the rectangular areas by distinguishing the rectangular areas from one another.

On the basis of the event signal 123, the tracking section 34 tracks a target area corresponding to the rectangular area identified by the identification section 33. Note that, in a case where the identification section 33 has identified a plurality of rectangular areas, the tracking section 34 tracks each of the rectangular areas as a target area. Note that the event signal 123 may be obtained by being accumulated in a buffer or by being constructed as an event image as in the first embodiment. For example, the event signals 123 with the same timestamp or timestamps within a certain range may be grouped and accumulated in the buffer as data indicating whether or not an event is present, the polarity of the event, and the like.

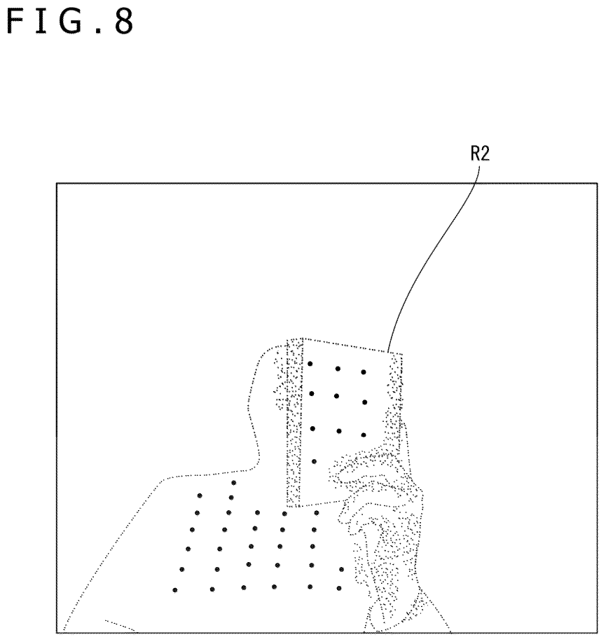

FIG. 8 is a diagram for describing tracking. FIG. 8 illustrates an example of an event image constructed on the basis of the event signal 123.

For example, in a case where the target is a person gripping a rectangular object such as a book with the left hand, the event image depicts portions such as the outline of the person and the contour of the gripped object which makes fine motion even while remaining still and which is subjected to luminance changes, as illustrated in FIG. 8. In the information processing apparatus 30, the identification section 33 identifies the rectangular object as a rectangular area R2, and the tracking section 34 tracks a target area corresponding to the rectangular area R2.

Then, the tracking section 34 outputs, to the distance information calculating section 31, tracking information indicating a tracking result.

Like the distance information calculating section 21 of the first embodiment, the distance information calculating section 31 calculates the distance information regarding the distance to the target on the basis of the difference between the irradiation start time when the irradiation section 111 starts irradiation and the light reception time when the light receiving section 112 receives light. At this time, the distance information calculating section 31 calculates the distance information in consideration of the information indicating the rectangular area which is output by the identification section 33 and the tracking information output by the tracking section 34.

The rectangular area identified by the identification section 33 described above can be assumed to be essentially present in a certain plane. For example, in the example in FIG. 8, the rectangular area R2 corresponding to the rectangular object gripped by the person can be assumed to be present on a front cover in a case where the rectangular object is a book. Thus, the distance information calculating section 31 calculates, for each rectangular area, the distance information regarding the distance to the target on the basis of the difference between the irradiation start time when the irradiation section 111 starts irradiation and the light reception time when the light receiving section 112 receives light. In other words, for a certain rectangular area, one piece of distance information is calculated for all the points in the rectangular area. In general, the density (resolution) of the distance information calculated on the basis of the output from the ToF sensor 11 is determined depending on the dot pattern radiated by the irradiation section 111 of the ToF sensor 11. However, as described above, by calculating the distance information according to the information regarding the rectangular area, the distance information can be calculated at higher density (higher resolution).

In addition, the rectangular area identified in the RGB image is useful as described above, but, on the other hand, the RGB image signal 133 has relatively lower time resolution than that of the event signal 123. Thus, on the basis of target areas in the tracking information output by the tracking section 34, the distance information calculating section 31 calculates the distance information for each of the target areas. In other words, in the information processing apparatus 30, the identification section 33 identifies the rectangular area on the basis of the RGB image, the tracking section 34 tracks the rectangular area as a target area on the basis of the event signal 123, and the distance information calculating section 31 calculates the distance information for each target area.

As described above, the distance information calculating section 31 calculates the distance information on the basis of the information indicating the rectangular area which is output by the identification section 33 and the tracking information output by the tracking section 34 in addition to the output from the ToF sensor 11. This increases the density (resolution) of calculation of the distance information based on the output from the ToF sensor 11 and also increases the frame rate in the time axis direction, allowing the accuracy of calculation of the distance information to be improved.

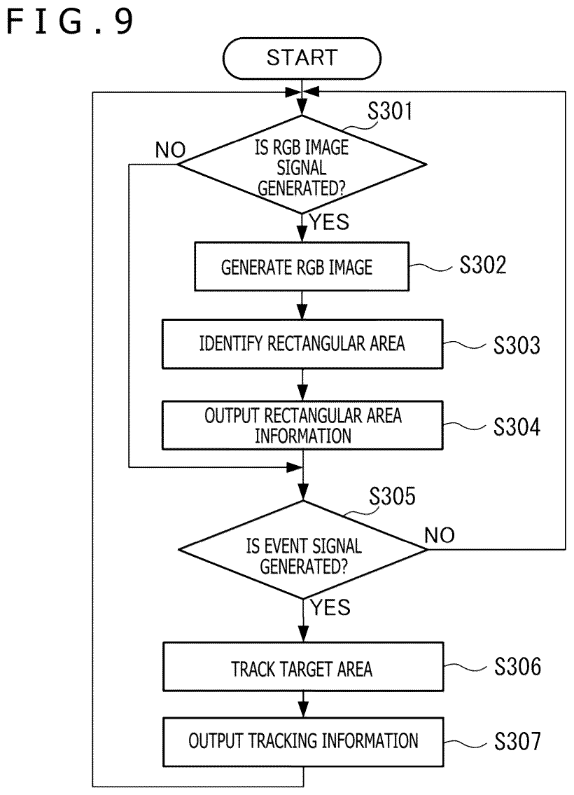

FIG. 9 is a flowchart illustrating an example of processing according to the second embodiment of the present invention. In the illustrated example, when the image sensor 131 of the RGB camera 13 generates an RGB image signal 133 (YES in step S301), the image generating section 32 of the information processing apparatus 30 generates an RGB image (step S302). Then, the identification section 33 identifies a rectangular area in the RGB image (step S303), and outputs information indicating the identified rectangular area to the distance information calculating section 31 and the tracking section 34 (step S304).

On the other hand, in a case where no RGB image signal 133 is generated even when a predetermined time has passed (NO in step S301) or in a case where the identification section 33 outputs the information indicating the identified rectangular area to the distance information calculating section 31 and the tracking section 34, the processing proceeds to step S305. Note that the predetermined time may be set according to the frame rate of the image sensor 131 of the RGB camera 13, for example.

When the sensor 121 of the EDS 12 generates an event signal 123 (YES in step S305), the tracking section 34 of the information processing apparatus 20 tracks the target area (step S306), and outputs, to the distance information calculating section 31, the tracking information indicating a tracking result (step S307). By repeating the processing in steps S301 to S307 described above, the sections of the information processing apparatus 30 can perform tracking on the basis of the event signal 123.

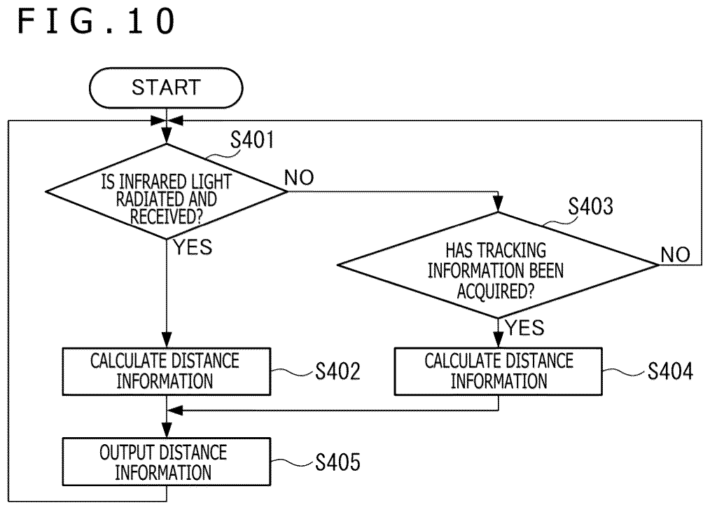

FIG. 10 is a flowchart illustrating another example of processing of the system 1 according to the second embodiment of the present invention. In the illustrated example, processing of calculating the distance information is executed according to the tracking information described with reference to FIG. 9.

When infrared light is radiated by the ToF sensor 11 and then received (YES in step S401), the distance information calculating section 31 calculates the distance information regarding the distance to the target on the basis of the difference between the irradiation start time when the irradiation section 111 starts irradiation and the light reception time when the light receiving section 112 receives light (step 402). On the other hand, in a case where no infrared light is radiated or received in spite of passage of a predetermined time (NO step S401), the distance information calculating section 31 determines whether or not complementary information has been acquired from the tracking section 34, and upon determining that the tracking information has been acquired (YES in step 403), calculates the distance information for each target area on the basis of the tracking information (step S404). Note that the predetermined time may be set according to the calculation frequency for the distance information based on the output from the ToF sensor 11.

Further, the distance information calculating section 31 outputs, from the information processing apparatus 30, the distance information calculated in step S402 or step S404 (step S405).

By repeating the processing in steps S401 to S405 described above, the sections of the information processing apparatus 30 can calculate the distance information while utilizing the tracking information as appropriate.

The second embodiment of the present invention as described above includes the identification section 33 that identifies at least one area in the RGB image acquired using the image sensor 131 that is a frame-based vision sensor, the tracking section 34 that tracks the target area corresponding to the area on the basis of the event signal 123 output by the sensor 121 that is an event-based sensor, and the distance information calculating section 31 that calculates, for each target area, the distance information on the basis of the difference between the irradiation start time and the light reception time for infrared light.

Therefore, the density (resolution) of the distance information calculation which is determined depending on the dot pattern radiated by the irradiation section 111 of the ToF sensor 11 is increased, allowing a higher density (higher resolution) to be achieved. In addition, the frame rate is increased in the time axis direction, allowing the accuracy of calculation of the distance information to be improved.

Note that, although the second embodiment illustrates the example in which the identification section 33 identifies the rectangular area in the RGB image generated by the image generating section 32, the present invention is not limited to this example. For example, the identification section 33 may identify an area having a shape other than a rectangle, such as a circle. In addition, the identification section 33 may identify an area detected by area detection processing such as known edge detection. Further, the identification section 33 may identify an area based on known background separation processing. In addition, the area identified by the identification section 33 may be set on the basis of user operation.

### Third Embodiment

A third embodiment of the present invention will be described below with reference to the drawings. In the third embodiment, only differences from the first embodiment and the second embodiment will be described, and description of portions of the third embodiment similar to those of the first embodiment and the second embodiment is omitted. In addition, in the third embodiment, the same reference signs are used to denote components having substantially the same functions and configurations as those in the first embodiment and the second embodiment.

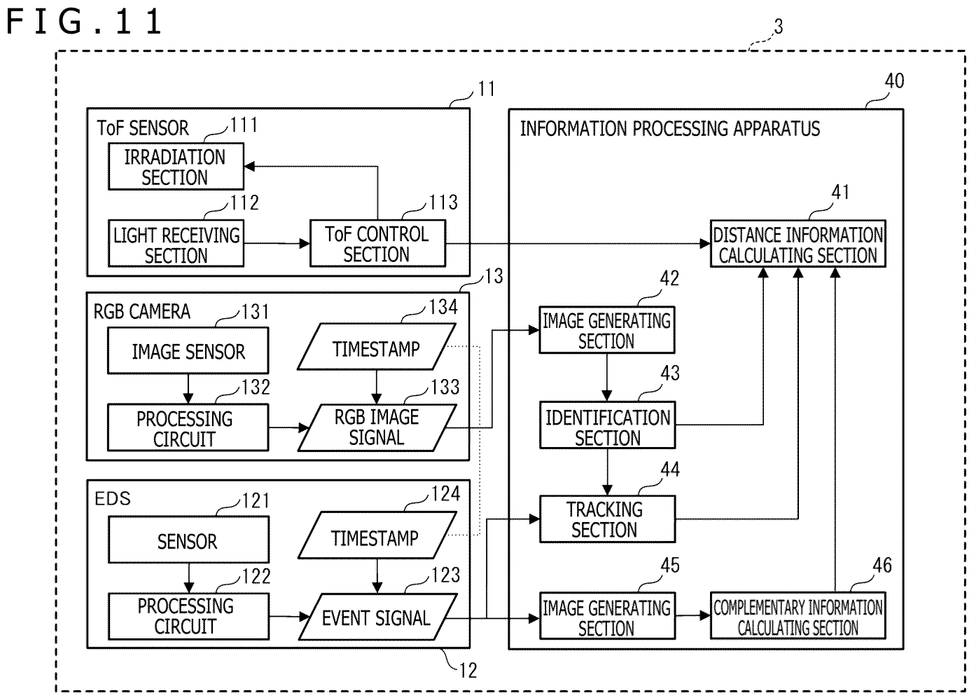

FIG. 11 is a block diagram illustrating a schematic configuration of a system 3.

The system 3 according to the third embodiment is a system having a configuration obtained by combining the system 1 of the first embodiment with the system 2 of the second embodiment, as illustrated in FIG. 11. In addition, the system 3 includes an information processing apparatus 40 instead of the information processing apparatus 20 of the system 1 of the first embodiment and the information processing apparatus 30 of the system 2 of the second embodiment.

The information processing apparatus 40 includes a distance information calculating section 41, an image generating section 42, an identification section 43, a tracking section 44, an image generating section 45, and a complementary information calculating section 46. The image generating section 42, the identification section 43, and the tracking section 44 of the information processing apparatus 40 have configurations similar to those of the image generating section 32, the identification section 33, and the tracking section 34 in the information processing apparatus 30 of the second embodiment. In addition, the image generating section 45 and the complementary information calculating section 46 of the information processing apparatus 40 have configurations similar to those of the image generating section 22 and the complementary information calculating section 23 of the information processing apparatus 20 of the first embodiment.

The information processing apparatus 40 of the third embodiment executes the processing of the information processing apparatus 20 of the first embodiment and the processing of the information processing apparatus 30 of the second embodiment. In other words, the information processing apparatus 40 performs both the calculation of the complementary information described with reference to the flowchart in FIG. 4 in the first embodiment and the tracking described with reference to the flowchart in FIG. 9 in the second embodiment.

Further, the information processing apparatus 40 includes the tracking information described in the second embodiment in the complementary information described in the first embodiment. Moreover, the distance information calculating section 41 executes the processing of calculating the distance information according to the complementary information described with reference to the flowchart in FIG. 5 in the first embodiment, allowing exertion of effects similar to those of the first embodiment and the second embodiment.

Note that the detailed processing in the information processing apparatus 40 is similar to the combination of the processing operations described in the first embodiment and the second embodiment and that illustration and description of a flowchart are thus omitted.

Note that, in each of the embodiments described above, the ToF sensor 11 may have any configuration. For example, the ToF sensor 11 may be a dToF (direct Time of Flight) sensor or may be an iToF (indirect Time of Flight) sensor. In particular, in a case where a dToF sensor is used as the ToF sensor 11, the dToF sensor, which has properties of being capable of accurately calculating distance information regarding even a target with low reflectivity and a remote target and saving power, can further improve the accuracy of calculation of the distance information.

In addition, in each of the embodiments described above, there is provided an example in which the ToF sensor 11 includes an infrared laser light source and radiates infrared light with a predetermined pattern as irradiation light. However, the present invention is not limited to this example. For example, the irradiation light may be ultraviolet light or may be visible light, depending on application.

In addition, in each of the embodiments described above, the number of the EDSs may be the same as or different from that of the RGB cameras. In addition, the numbers of the EDSs and the RGB cameras may each be one or more. For example, in a case where a plurality of RGB cameras are provided, the range of field of photography in which an RGB image signal is generated can be extended, or the state of a person can be three-dimensionally estimated from a plurality of RGB image signals. In addition, for example, in a case where a plurality of EDSs are provided, the range of field of photography in which an event signal is generated can be extended, or the three-dimensional moving distance of a person can be calculated on the basis of a plurality of event signals.

In addition, the distance information described in each of the embodiments described above may be utilized in any manner. For example, the distance information may be utilized in a rendering system that uses motion of a user for rendering of a CG (Computer graphics) model, a mirroring system that reproduces the motion of the user by a robot or the like, a gaming system that receives user operation similarly to a controller, and the like.

In addition, there have been provided examples in which the target is a person. However, the present invention is similarly applicable in a case where the target is other than a person, for example, where the target is a predetermined vehicle, machine, organism, or the like, and in a case where the target is a predetermined marker or the like.

In addition, the system 1, the system 2, and the system 3 described in each of the embodiments described above may be implemented in a single apparatus or may be distributively implemented in a plurality of apparatuses. For example, the system may include a camera unit including the ToF sensor 11 and a camera (an RGB camera and an EDS) and the information processing apparatus. In addition, the camera unit may be a unit that can be installed on the body of the user, such as an HMD (Head-Mounted Display) unit.

Further, part or all of the processing in the information processing apparatus may be executed by a server (for example, a cloud server) to which the information processing apparatus is communicably connected by an Internet communication network or in a wireless manner.

The several embodiments of the present invention have been described above in detail with reference to the attached drawings. However, the present invention is not limited to such examples. Obviously, a person having ordinary knowledge in the field of technology to which the present invention belongs could easily conceive of various kinds of variations or modifications within the scope of technical concepts recited in claims. It is comprehended that, needless to say, these variations or modifications also belong to the technical scope of the present invention.

### REFERENCE SIGNS LIST

1, 2, 3: System
11: ToF sensor
12: EDS
13: RGB camera
20, 30, 40: Information processing apparatus
21, 31, 41: Distance information calculating section
22, 32, 42, 45: Image generating section
23, 46: Complementary information calculating section
33, 43: Identification section
34, 44: Tracking section
111: Irradiation section
112: Light receiving section
113: ToF control section
121: Sensor
122, 132: Processing circuit
123: Event signal
131: Image sensor
133: RGB image signal

1. An information processing apparatus that calculates distance information regarding a distance to a target irradiated with light with a predetermined pattern, the information processing apparatus comprising:
an identification section that identifies at least one area in an image acquired using a frame-based vision sensor;
a tracking section that tracks a target area corresponding to the area identified by the identification section, on a basis of an event signal output by an event-based sensor; and
a calculation section that calculates, for each of the target areas, the distance information on a basis of a difference between an irradiation start time and a light reception time for the light with the predetermined pattern.

2. The information processing apparatus according to claim 1, wherein the light with the predetermined pattern is infrared light.

3. The information processing apparatus according to claim 1, comprising:
a generation section that constructs an image on a basis of the event signal; and
a second calculation section that calculates complementary information that complements the distance information, on a basis of a change in a shape of the predetermined pattern in the image generated by the generation section.

4. The information processing apparatus according to claim 3, wherein the complementary information is information indicating a moving direction of the target.

5. The information processing apparatus according to claim 3, wherein
the complementary information is information indicating a moving distance of the target.

6. The information processing apparatus according to claim 3, wherein
the predetermined pattern includes a figure, and
the change in the shape of the predetermined pattern includes at least one of a change in a size of the figure and a change in a position of the figure.

7. A system comprising:
a frame-based vision sensor;
an event-based sensor;
an irradiation section that irradiates a target with light with a predetermined pattern; and
a light receiving section that receives reflected light from the target; and
an information processing apparatus including
an identification section that identifies at least one area in an image acquired using the frame-based vision sensor,
a tracking section that tracks a target area corresponding to the area identified by the identification section, on a basis of an event signal output by the event-based sensor, and
a calculation section that calculates, for each of the target areas, the distance information on a basis of a difference between an irradiation start time and a light reception time for the light with the predetermined pattern.

8. The system according to claim 7, wherein
the irradiation section radiates infrared light as the light with the predetermined pattern.

9. The system according to claim 7, wherein the information processing apparatus includes
a generation section that constructs an image on a basis of the event signal, and
a second calculation section that calculates complementary information that complements the distance information, on a basis of a change in a shape of the predetermined pattern in the image generated by the generation section.

10. The system according to claim 9, wherein
the complementary information is information indicating a moving direction of the target.

11. The system according to claim 9, wherein
the complementary information is information indicating a moving distance of the target.

12. The system according to claim 9, wherein
the predetermined pattern includes a figure, and
the change in the shape of the predetermined pattern includes at least one of a change in a size of the figure and a change in a position of the figure.

13. The system according to claim 7, wherein
the information processing apparatus is a server.

14. An information processing method of calculating distance information regarding a distance to a target irradiated with light with a predetermined pattern, the information processing method comprising:
identifying at least one area in an image acquired using a frame-based vision sensor;
tracking a target area corresponding to the identified area on a basis of an event signal output by an event-based sensor; and
calculating, for each of the target areas, the distance information on a basis of a difference between an irradiation start time and a light reception time for the light with the predetermined pattern.

15. An information processing program for a computer, including, by an information processing apparatus, calculating distance information regarding a distance to a target irradiated with light with a predetermined pattern, the information processing program for the computer, comprising:
by an identification section, identifying at least one area in an image acquired using a frame-based vision sensor;
by a tracking section, tracking a target area corresponding to the identified area on a basis of an event signal output by an event-based sensor; and
by a calculation section, calculating, for each of the target areas, the distance information on a basis of a difference between an irradiation start time and a light reception time for the light with the predetermined pattern.

16. A computer system comprising:
a memory configured to store a program code; and
a processor configured to process the program code to execute an operation,
the operation including
identifying at least one area in an image acquired using a frame-based vision sensor,
tracking a target area corresponding to the identified area on a basis of an event signal output by an event-based sensor, and
calculating, for each of the target areas, the distance information on a basis of a difference between an irradiation start time and a light reception time for the light with the predetermined pattern.
